(19) United States
(12) Patent Application Publication
(10) Pub. No.: US 2020/0134567 A1
(43) Pub. Date: Apr. 30, 2020

(54) System and Method for Searching and Sharing of Virtual Business Cards

(71) Applicant: VIJAYAKUMAR LAKSHMI VENKATA NAGENDRA MANDELLI, ROCHESTER, NY (US)

(72) Inventor: VIJAYAKUMAR LAKSHMI VENKATA NAGENDRA MANDELLI, ROCHESTER, NY (US)

(21) Appl. No.: 16/666,769

(22) Filed: Oct. 29, 2019

Related U.S. Application Data
(60) Provisional application No. 62/752,202, filed on Oct. 29, 2018.

(51) Int. Cl. G06Q 10/10; G06Q 50/00

(52) U.S. Cl. CPC G06Q 10/109; G06Q 10/1097; G06Q 50/01

(57) ABSTRACT

A system and method for searching and sharing virtual business cards allows a user to share his or her contact information and business information and/or request access to the contact information and business information of another user. The system includes at least one remote server used to manage a plurality of user accounts. Each user account is managed by a personal computing device and includes a virtual business card. The virtual business card includes contact information and business information of each user. A user can share his or her virtual business card through the system and method. Further, a user can request to view the virtual business card of a secondary user. The user can select the secondary user from a plurality of matching accounts. If the secondary user accepts the request, the user and the secondary user are granted access to view the virtual business cards of each other.

The current application claims a priority to the U.S. Provisional Patent application Ser. No. 62/752,202 filed on Oct. 29, 2018.

### FIELD OF THE INVENTION

The present invention generally relates to systems and methods for data transfer and storage. More specifically, the present invention relates to systems and methods which enable the sharing and searching of virtual business cards.

### BACKGROUND OF THE INVENTION

Business cards have been part of society for hundreds of years. Traditionally, business cards comprise rectangular thin bodies made from different materials, such as paper or cardboard. Further, personal or business information is provided on one or both sides of the business card. As soon as a new connection is made, it is a common practice to exchange business cards for future reference. Unfortunately, business cards are so easy to lose or misplace due to the size of most business cards. People often have trouble looking for business cards in a purse or wallet for a specific business card of a specific person met previously. In addition, business cards are hard to properly store and organize. Various technologies have been provided to help people better store and organize business cards. For example, different electronic devices such as mobile phones have been provided with capabilities to store and organize the information of business cards. However, the business card information is often required to be input manually into the electronic device. It is a common occurrence for people to spend minutes exchanging phone numbers with other people and properly save the numbers under the correct name by trying to spell the other person's name. Newer software applications have been provided to facilitate the storing and organizing of business cards. However, these newer software applications often lack an intuitive and practical method for sharing business card information between various people. There is a need for better systems which enable easy storage and organization of business cards as well as methods for practical business card information sharing.

An objective of the present invention is to provide a system and method for searching and sharing virtual business cards. The present invention allows users to share a virtual business card to other nearby users with the use of a software application. The software application of the present invention allows users from all walks of life to share business card information with each other in a quick and easy way. Users can create an account with the software application of the present invention by inputting the users' information. The software application of the present invention will automatically process the users' information to create a virtual business card. Furthermore, the present invention will provide a system which lets users customize the virtual business cards from pre-existing templates or request custom templates. In the preferred embodiment of the present invention, the present invention can show users of nearby users with whom virtual business cards can be shared. The present invention can allow users to configure a plurality of settings including, but not limited to, sharing preferences, privacy preferences, etc.

### SUMMARY OF THE INVENTION

The present invention provides a system and method for sharing and searching virtual business cards. In the preferred embodiment of the present invention, the present invention provides a software application which can be installed on or accessed through an electronic device. The software application allows users to exchange users' business card information with each other in an easy and practical manner. The software application of the present invention can display users' business card information from any location, allowing users to connect with other users anywhere. Further, the software application of the present invention allows users to set search preferences to desired settings to find other users with whom business card information can be shared. By default, the software application of the present invention will assign a default virtual business card with the users' profile but can further provide customization options. Furthermore, the users can see nearby users at events and can easily connect with nearby users to exchange user information along with the virtual business card. The software application of the present invention will automatically process the exchanged user information and store the user information for future use.

### BRIEF DESCRIPTION OF THE DRAWINGS

FIG. 1 is a block diagram illustrating the overall system of the present invention.

FIG. 2 is a flowchart illustrating the overall method of the present invention.

FIG. 3 is a block diagram illustrating the system of the present invention with the third-party server, the GPS module, and the communication platform.

FIG. 4 is a flowchart illustrating one subprocess of determining the plurality of matching accounts.

FIG. 5 is a flowchart illustrating the subprocess of determining the desired search radius.

FIG. 6 is a flowchart illustrating the subprocess that allows a user to view the plurality of proximal accounts in order to select the specific account.

FIG. 7 is a flowchart illustrating another subprocess of determining the plurality of matching accounts.

FIG. 8 is a flowchart illustrating the subprocess of determining the desired search radius.

FIG. 9 is a flowchart illustrating the subprocess of determining the specified location.

FIG. 10 is a flowchart illustrating the subprocess that allows a user to view the plurality of proximal accounts in order to select the specific account.

FIG. 11 is a flowchart illustrating the subprocess that allows a user to provide contact information and business information for the virtual business card.

FIG. 12 is a flowchart illustrating the subprocess that allows a user to customize the virtual business card.

FIG. 13 is a flowchart illustrating the subprocess that allows uses to communicate with each other through the present invention.

FIG. 14 is a flowchart illustrating the subprocess that allows a user to share the virtual business card on the third-party server.

FIG. 15 is a flowchart illustrating the subprocess that allows notifies the user of a calendar reminder.

FIG. 16 is a flowchart illustrating the subprocess that allows a user to manually enter a calendar reminder.

### DETAIL DESCRIPTIONS OF THE INVENTION

All illustrations of the drawings are for the purpose of describing selected versions of the present invention and are not intended to limit the scope of the present invention.

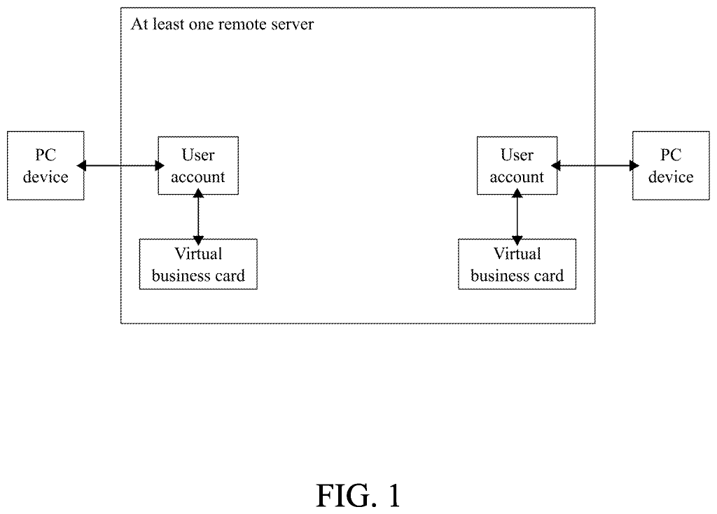

In reference to FIGS. 1 through 16, the present invention is a system and method for searching and sharing virtual business cards which allows users to easily and digitally exchange contact information and business information. In further detail, the present invention is a software application that allows a user to share his or her contact information and business information and/or request access to the contact information and business information of another user. With reference to FIG. 1, the system of the present invention includes at least one remote server that is used to manage a plurality of user accounts (Step A). The remote server is preferably a cloud server that can manage, and store information and inputs processed through the present invention. The plurality of user accounts is a set of accounts which allow a user to interact with the present invention. Each user account is associated with a corresponding personal computing (PC) device. The corresponding PC device may be any computing device such as, but not limited to, a desktop computer, a laptop computer, a smartphone, or an electronic tablet. Further, each user account includes a virtual business card. The virtual business card is a digital business card that includes contact information and business information.

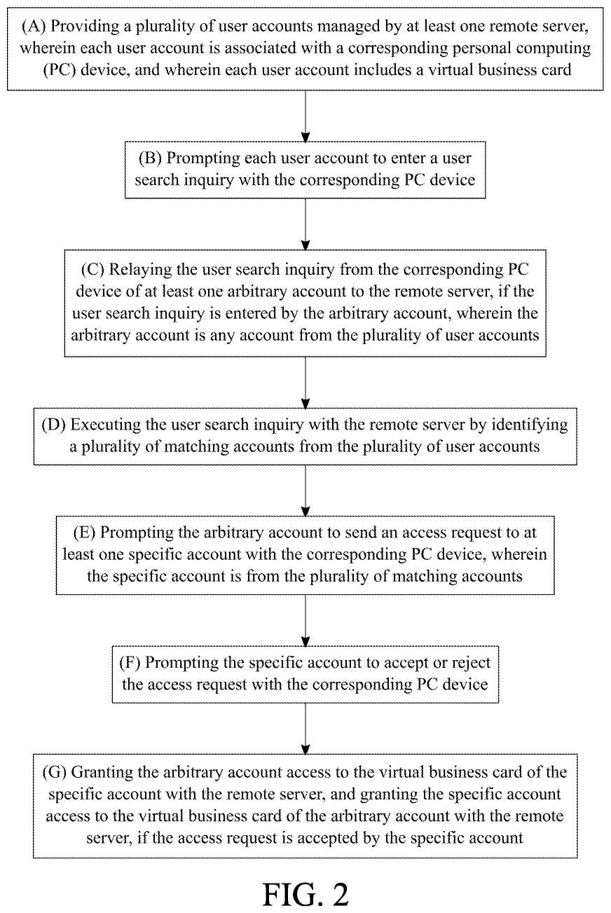

With reference to FIG. 2, the method of the present invention follows an overall process which allows a user to request access to the contact information and business information of another user. The corresponding PC device is used to prompt each user account to enter a user search inquiry (Step B). The user search inquiry is preferably a location-based search request that can be customized by a user. The user search inquiry is relayed from the corresponding PC device at least one arbitrary account to the remote server, if the user search inquiry is entered by the arbitrary account (Step C). Thus, the remote server is given the command to process the user search inquiry. The arbitrary account is any account from the plurality of user accounts. The remote server is used to execute the user search inquiry by identifying a plurality of matching accounts from the plurality of user accounts (Step D). The plurality of matching accounts is a set of accounts which meet the customized requirements of the user search inquiry. The corresponding PC device is then used to prompt the arbitrary account to send an access request to at least one specific account (Step E). In further detail, Step E allows a user to request the contact information and business information of another user of the present invention. Thus, the access request is a request to exchange contact information and business information with another user of the present invention. The specific account is from the plurality of matching accounts. The corresponding PC device is used to prompt the specific account to accept or reject the access request (Step F). Thus, the specific account is given the option to grant or deny access to his or her contact information and business information. The remote server is used to grant the arbitrary account access to the virtual business card of the specific account and grant the specific account access to the virtual business card of the arbitrary account, if the access request is accepted by the specific account (Step G). Thus, the contact information and business information of the arbitrary account is exchanged with the contact information and business information of the specific account. In further detail, the arbitrary account is now able to view the virtual business card of the specific account and the specific account is now able to view the virtual business card of the arbitrary account.

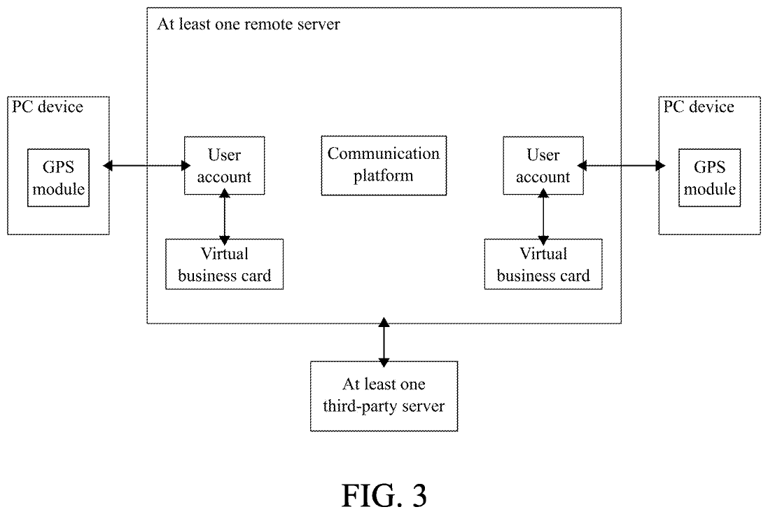

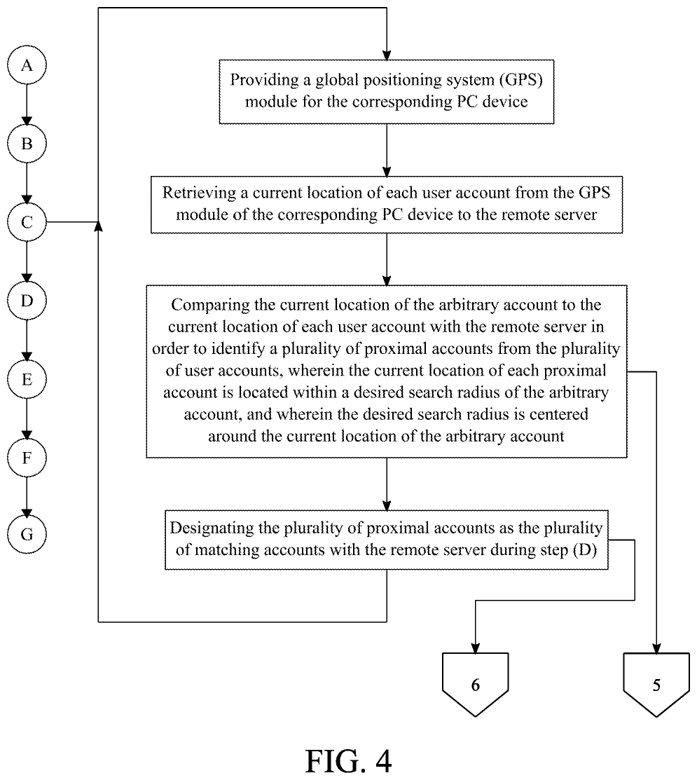

With reference to FIGS. 3 and 4, the following subprocess is one method used to determine the plurality of matching accounts. A global positioning system (GPS) module is provided for the corresponding PC device. The GPS module is a geolocation tracking device that can continuously monitor the geolocation of a computing device. A current location of each user account is retrieved from the GPS module of the corresponding PC device to the remote server. The current location is a live geolocation read by the GPS module of the corresponding PC device. The current location of the arbitrary account is compared to the current location of each user account with the remote server in order to identify a plurality of proximal accounts from the plurality of user accounts. The plurality of proximal accounts is a set of accounts which belong to users which are physically located near the user of the arbitrary account. The current location of each proximal account is located within a desired search radius of the arbitrary account. The desired search radius is a virtual radius that can be customized by a user. The desired search radius is centered around the current location of the arbitrary account. The remote server is then used to designate the plurality of proximal account as the plurality of matching accounts during Step D. Thus, the plurality of matching accounts is determined using a location-based process.

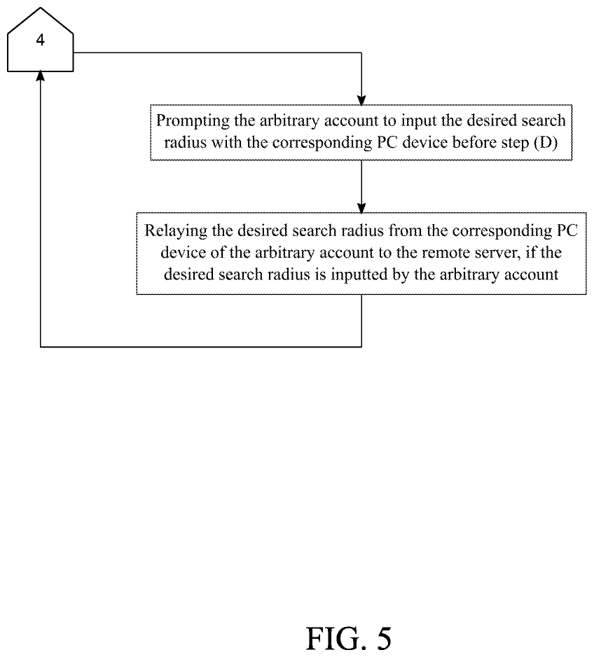

With reference to FIG. 5, the following subprocess is used to determine the desired search radius. The corresponding PC device is used to prompt the arbitrary account to input the desired search radius before Step D. This step allows a user to customize the desired search radius to any radius such as, but not limited to, 5 miles or km, 15 miles or km, or 25 miles or km. The desired search radius is relayed from the corresponding PC device of the arbitrary account to the remote server, if the desired search radius is inputted by the arbitrary account. Thus, the remote server is provided with the desired search radius in order to identify the plurality of proximal accounts.

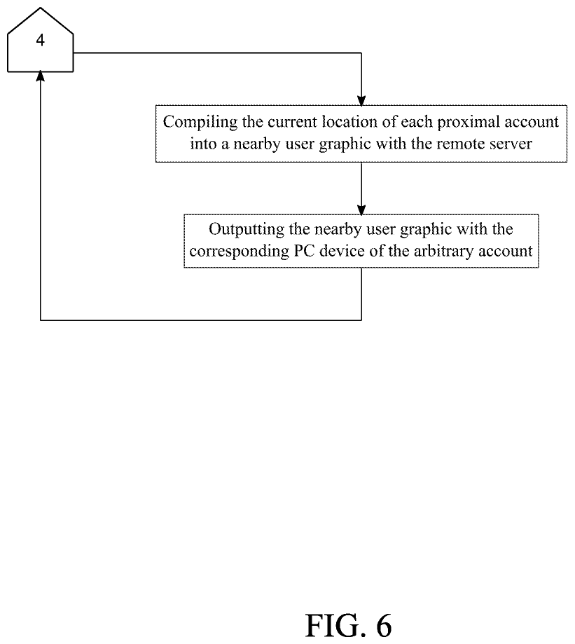

With reference to FIG. 6, the following subprocess allows a user to view the plurality of proximal accounts in order to select the specific account. The remote server is used to compile the current location of each proximal account into a nearby user graphic. The nearby user graphic displays the plurality of proximal accounts to a user and how distant the plurality of proximal accounts is from a user. In further detail, the name of each proximal account, the approximal distance of each proximal account, and the type of business of each proximal account is displayed to the user searching for the plurality of proximal accounts. Thus, a user can easily select the specific account. The nearby user graphic is outputted with the corresponding PC device of the arbitrary account. Thus, the arbitrary account is able to view the plurality of proximal accounts in order to easily select the specific account.

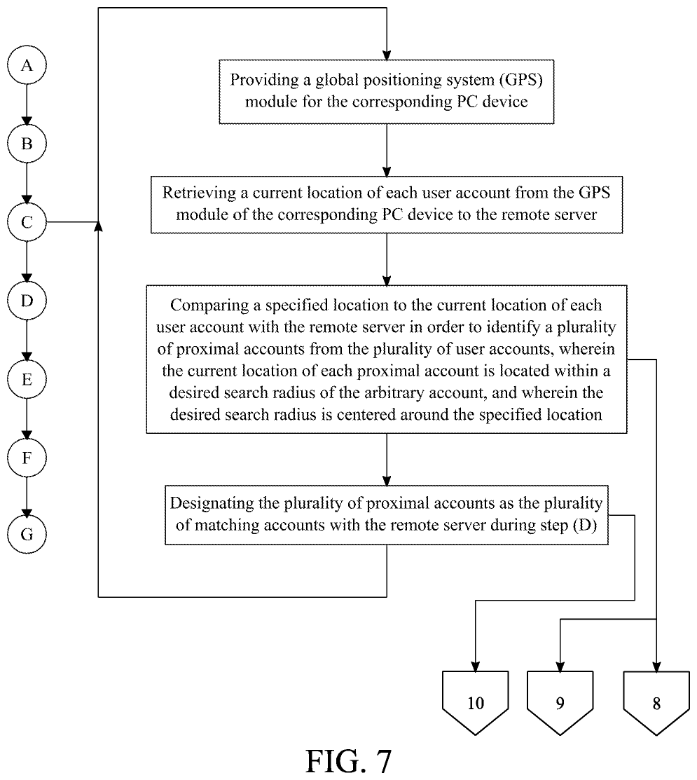

Alternatively and with reference to FIG. 7, the current location of each user account is retrieved from the GPS module of the corresponding PC device to the remote server. The current location of the arbitrary account is compared to a specified location of each user account with the remote server in order to identify a plurality of proximal accounts from the plurality of user accounts. The specified location is any location that can be inputted by the user in order to search for distant users of the present invention. The current location of each proximal account is located within a desired search radius of the arbitrary account. The desired search radius is centered around the specified location. The remote server is then used to designate the plurality of proximal account as the plurality of matching accounts during Step D.

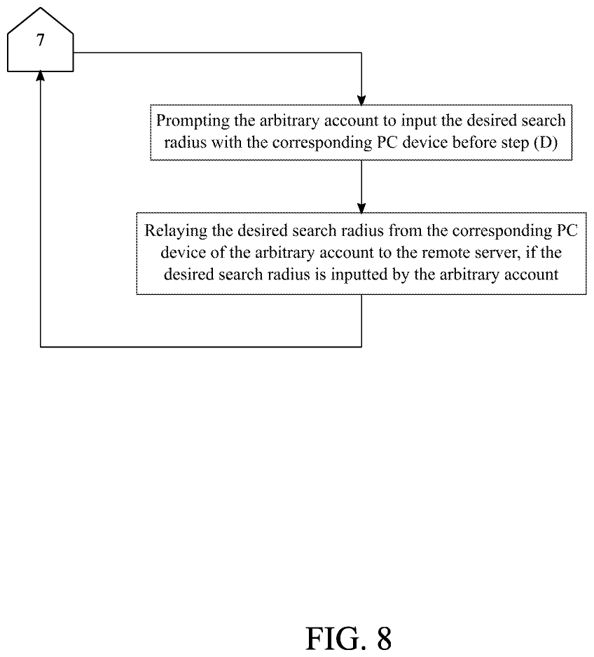

With reference to FIG. 8, the following subprocess is used to determine the desired search radius. The corresponding PC device is used to prompt the arbitrary account to input the desired search radius before Step D. The desired search radius is relayed from the corresponding PC device of the arbitrary account to the remote server, if the desired search radius is inputted by the arbitrary account.

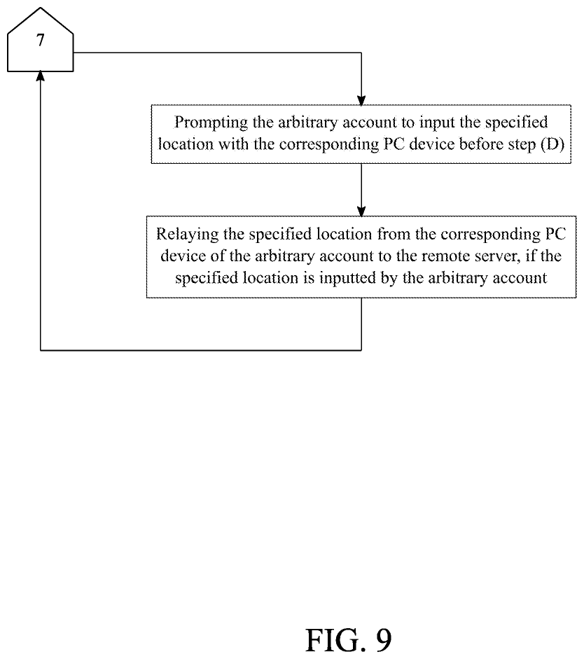

With reference to FIG. 9, the following subprocess is used to determine the specified location. The corresponding PC device is used to prompt the arbitrary account to input the specified location before Step D. As mentioned previously, the arbitrary account can enter any location in order to search for users that are physically distant from the arbitrary account. The specified location is relayed from the corresponding PC device of the arbitrary account to the remote server, if the specified location is inputted by the arbitrary account. Thus, the remote server is provided the specified location in order to identify the plurality of proximal accounts.

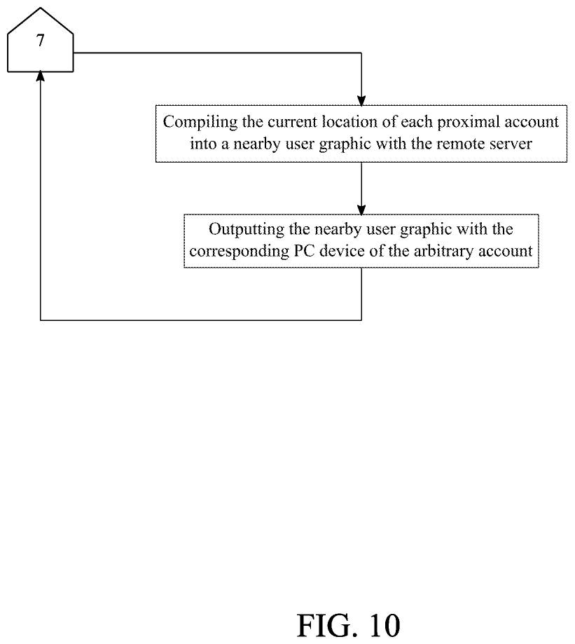

With reference to FIG. 10, the following subprocess allows a user to view the plurality of proximal accounts in order to select the specific account. The remote server is used to compile the current location of each proximal account into a nearby user graphic. The nearby user graphic is outputted with the corresponding PC device of the arbitrary account.

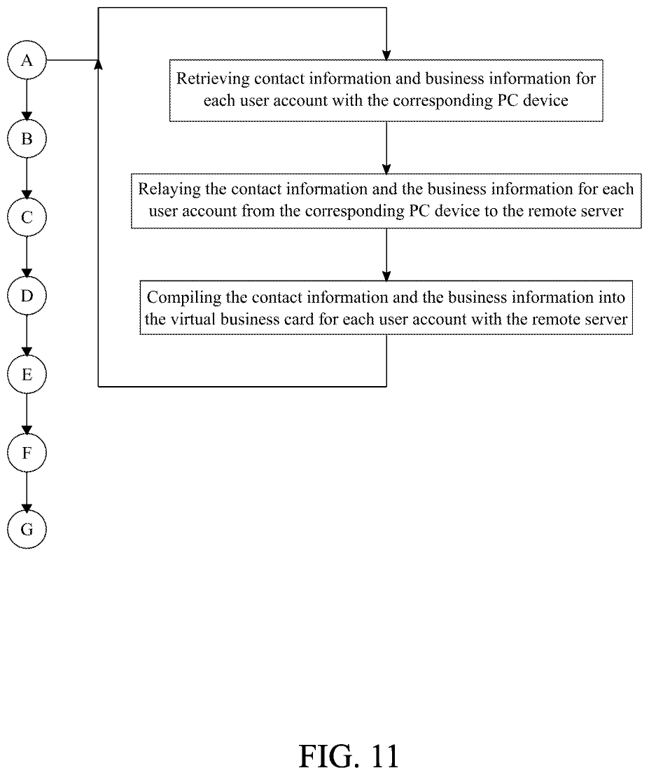

With reference to FIG. 11, the following subprocess allows a user to provide information for the virtual business card. Contact information and business information is retrieved for each user account with the corresponding PC device. Contact information may include, but is not limited, the name of a user, the phone number of the user, and the email address of the user. The business information may include, but is not limited to, a brief company description, a company phone number, and a company address. In further detail, the user is able to provide his or her contact information and business information through the corresponding PC device. The contact information and the business information for each user account is relayed from the corresponding PC device to the remote server. Thus, the remote server is provided with the contract information and the business information for the virtual business card. The remote server is used to compile the contact information and business information into the virtual business card. Thus, the virtual business card displays contact information and business information of the respective user.

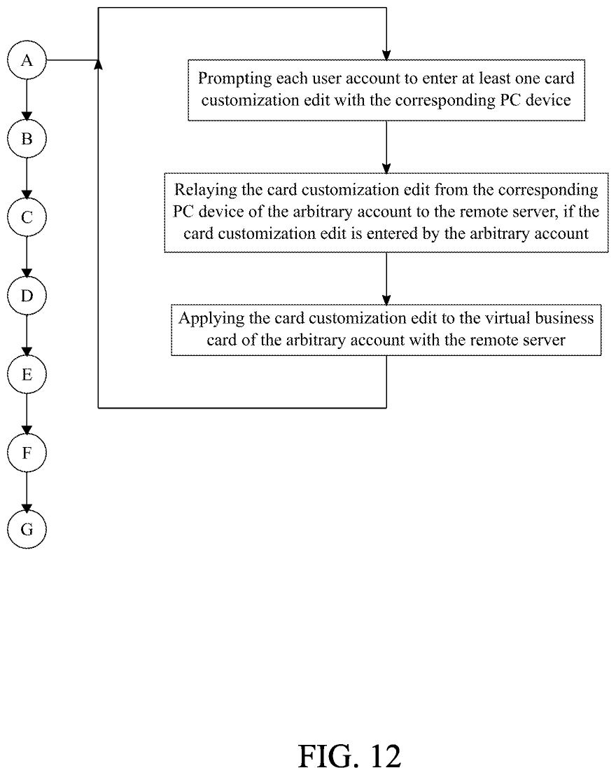

With reference to FIG. 12, the following subprocess allows a user to customize the virtual business card. The corresponding PC device is used to prompt each user account to enter at least one card customization edit. The card customization edit may be, but is not limited to, a virtual business card style change, a change to what the virtual business card displays, and/or an upload of company logos or profiles. The card customization edit is relayed from the corresponding PC device of the arbitrary account to the remote server, if the card customization edit is entered by the arbitrary account. Thus, the remote server is provided with the card customization edit in order to edit the virtual business card. The remote server is then used to apply the card customization edit to the virtual business card. Thus, the virtual business card is edited by the user.

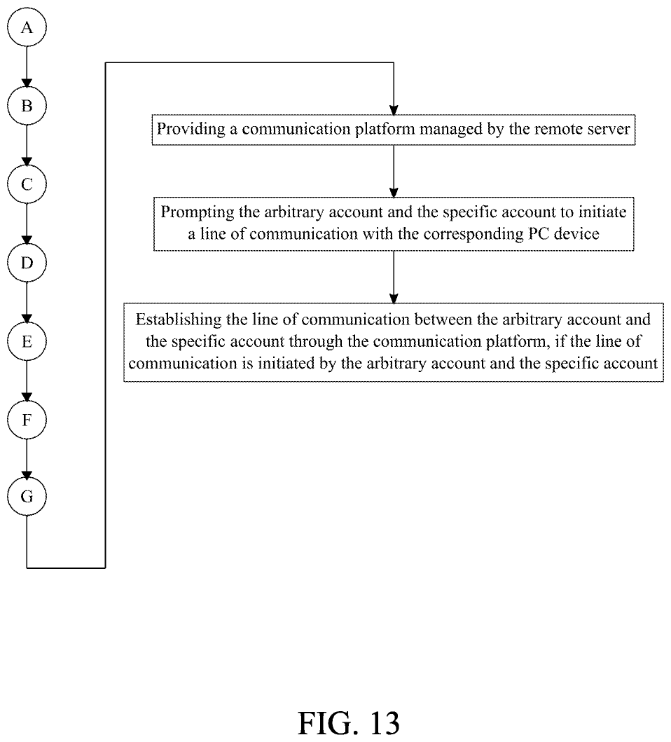

With reference to FIGS. 3 and 13, the following subprocess allows users to communicate with each other through the present invention. The remote server is used to manage a communication platform. The communication platform is a platform where users can text message and/or voice call each other. The corresponding PC device is used to prompt the arbitrary account and the specific account to initiate a line a communication. The line of communication may be, but is not limited to, a text conversation or phone conversation. The line of communication between the arbitrary account and the specific account is established through the communication platform, if the line of communication is initiated by the arbitrary account and the specific account. Thus, users can communication with each other through the present invention in order to discuss company details or other similar topics.

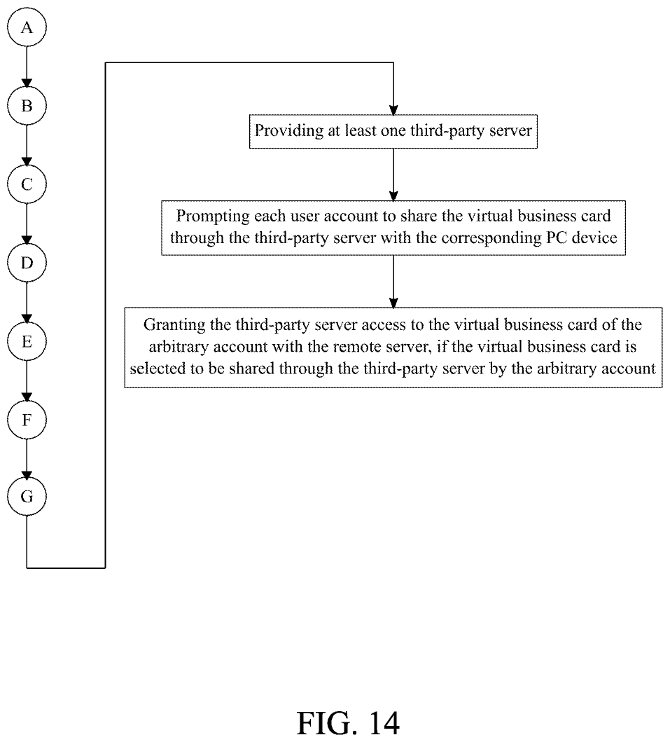

With reference to FIGS. 3 and 14, the following subprocess allows users to share the virtual business card on third-party platforms. At least one third-party server may be provided. The third-party server may be a server attached to any social media platform. The corresponding PC device is used to prompt each user account to share the virtual business card through the third-party server. In further detail, this step provides a user the option to share the virtual business card by, but not limited to, posting the virtual business card on the platform of the third-party server or by posting a link, to the virtual business card, on the platform of the third-party server. The remote server is then used to grant the third-party server access to the virtual business card of the arbitrary account, if the virtual business card is selected to be shared through the third-party server by the arbitrary account. Thus, a user can share the virtual business card on a third-party platform. Alternatively, a user can share the virtual business card by sending the virtual business card to an email address and/or a memory storage server.

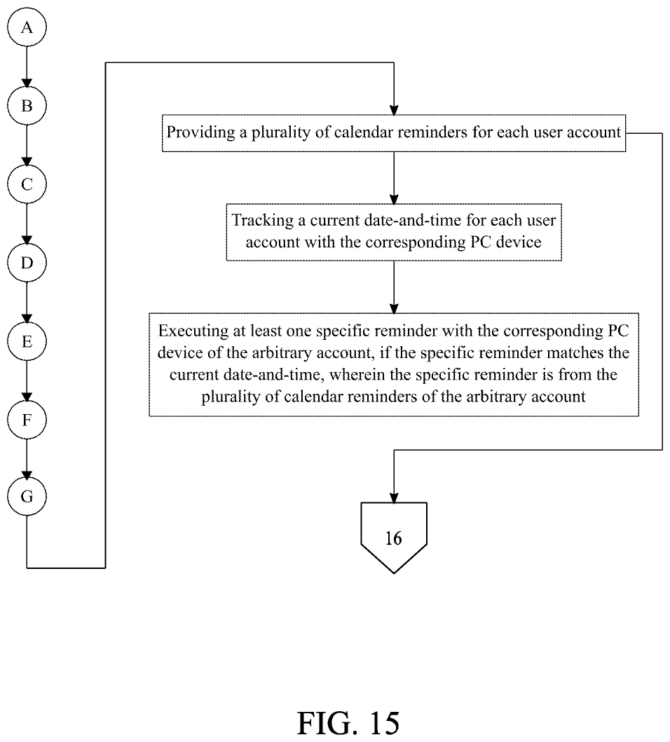

With reference to FIG. 15, the following subprocess notifies a user of an event. A plurality of calendar reminder is provided for each user account. The plurality of calendar reminders is a set of reminders of specific dates and/or times. The plurality of calendar reminders may be default reminders such as, but not limited to, holidays. Further, the plurality of calendar reminders may be manually entered by a user. The corresponding PC device is used to track a current date-and-time for each user account. The current date-and-time is a live reading of the day and time. The corresponding PC device of the arbitrary account is used to execute at least one specific reminder, if the specific reminder matches the current date-and-time. The specific reminder is from the plurality of calendar reminders of the arbitrary account. Thus, a user is notified of an event such as, but not limited to, a meeting or conference.

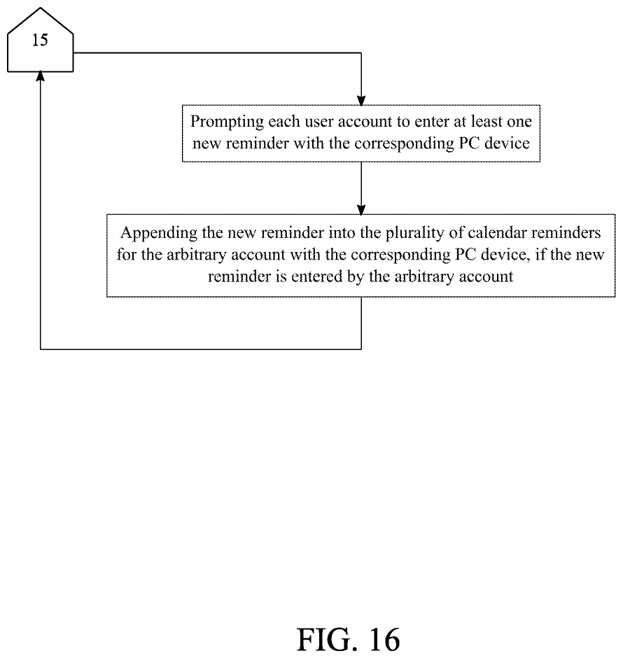

With reference to FIG. 16, the following subprocess allows a user to manually enter a calendar reminder. The corresponding PC device is used to prompt each user account to enter at least one new reminder. The new reminder may be a date-and-time for any event such as, but not limited, a meeting or conference. The new reminder is appended into the plurality of calendar reminders for the arbitrary account with the corresponding PC device, if the new reminder is entered by the arbitrary account. Thus, a calendar reminder is manually entered by a user.

Although the invention has been explained in relation to its preferred embodiment, it is to be understood that many other possible modifications and variations can be made without departing from the spirit and scope of the invention as hereinafter claimed.

What is claimed is:

1. A method of searching and sharing of virtual business cards, the method comprises the steps of:
(A) providing a plurality of user accounts managed by at least one remote server, wherein each user account is associated with a corresponding personal computing (PC) device, and wherein each user account includes a virtual business card;
(B) prompting each user account to enter a user search inquiry with the corresponding PC device;
(C) relaying the user search inquiry from the corresponding PC device of at least one arbitrary account to the remote server, if the user search inquiry is entered by the arbitrary account, wherein the arbitrary account is any account from the plurality of user accounts;
(D) executing the user search inquiry with the remote server by identifying a plurality of matching accounts from the plurality of user accounts;
(E) prompting the arbitrary account to send an access request to at least one specific account with the corresponding PC device, wherein the specific account is from the plurality of matching accounts;
(F) prompting the specific account to accept or reject the access request with the corresponding PC device; and
(G) granting the arbitrary account access to the virtual business card of the specific account with the remote server, and granting the specific account access to the virtual business card of the arbitrary account with the remote server, if the access request is accepted by the specific account.

2. The method of searching and sharing of virtual business cards as claimed in claim 1 comprises the steps of:
providing a global positioning system (GPS) module for the corresponding PC device
retrieving a current location of each user account from the GPS module of the corresponding PC device to the remote server;
comparing the current location of the arbitrary account to the current location of each user account with the remote server in order to identify a plurality of proximal accounts from the plurality of user accounts, wherein the current location of each proximal account is located within a desired search radius of the arbitrary account, and wherein the desired search radius is centered around the current location of the arbitrary account; and
designating the plurality of proximal accounts as the plurality of matching accounts with the remote server during step (D).

3. The method of searching and sharing of virtual business cards as claimed in claim 2 comprises the steps of:
prompting the arbitrary account to input the desired search radius with the corresponding PC device before step (D); and
relaying the desired search radius from the corresponding PC device of the arbitrary account to the remote server, if the desired search radius is inputted by the arbitrary account.

4. The method of searching and sharing of virtual business cards as claimed in claim 2 comprises the steps of:
compiling the current location of each proximal account into a nearby user graphic with the remote server; and
outputting the nearby user graphic with the corresponding PC device of the arbitrary account.

5. The method of searching and sharing of virtual business cards as claimed in claim 1 comprises the steps of:
providing a GPS module for the corresponding PC device
retrieving a current location of each user account from the GPS module of the corresponding PC device to the remote server;
comparing a specified location of the arbitrary account to the current location of each user account with the remote server in order to identify a plurality of proximal accounts from the plurality of user accounts, wherein the current location of each proximal account is located within a desired search radius of the arbitrary account, and wherein the desired search radius is centered around the specified location; and
designating the plurality of proximal accounts as the plurality of matching accounts with the remote server during step (D).

6. The method of searching and sharing of virtual business cards as claimed in claim 5 comprises the steps of:
prompting the arbitrary account to input the desired search radius with the corresponding PC device before step (D); and
relaying the desired search radius from the corresponding PC device of the arbitrary account to the remote server, if the desired search radius is inputted by the arbitrary account.

7. The method of searching and sharing of virtual business cards as claimed in claim 5 comprises the steps of:
prompting the arbitrary account to input the specified location with the corresponding PC device before step (D); and
relaying the specified location from the corresponding PC device of the arbitrary account to the remote server, if the specified location is inputted by the arbitrary account.

8. The method of searching and sharing of virtual business cards as claimed in claim 5 comprises the steps of:
compiling the current location of each proximal account into a nearby user graphic with the remote server; and
outputting the nearby user graphic with the corresponding PC device of the arbitrary account.

9. The method of searching and sharing of virtual business cards as claimed in claim 1 comprises the steps of:
retrieving contact information and business information for each user account with the corresponding PC device;
relaying the contact information and the business information for each user account from the corresponding PC device to the remote server; and
compiling the contact information and the business information into the virtual business card for each user account with the remote server.

10. The method of searching and sharing of virtual business cards as claimed in claim 1 comprises the steps of:
prompting each user account to enter at least one card customization edit with the corresponding PC device;
relaying the card customization edit from the corresponding PC device of the arbitrary account to the remote server, if the card customization edit is entered by the arbitrary account; and
applying the card customization edit to the virtual business card of the arbitrary account with the remote server.

11. The method of searching and sharing of virtual business cards as claimed in claim 1 comprises the steps of:
providing a communication platform managed by the remote server;
prompting the arbitrary account and the specific account to initiate a line of communication with the corresponding PC device; and
establishing the line of communication between the arbitrary account and the specific account through the communication platform, if the line of communication is initiated by the arbitrary account and the specific account.

12. The method of searching and sharing of virtual business cards as claimed in claim 1 comprises the steps of:
providing at least one third-party server;
prompting each user account to share the virtual business card through the third-party server with the corresponding PC device; and
granting the third-party server access to the virtual business card of the arbitrary account with the remote server, if the virtual business card is selected to be shared through the third-party server by the arbitrary account.

13. The method of searching and sharing of virtual business cards as claimed in claim 1 comprises the steps of:
providing a plurality of calendar reminders for each user account;
tracking a current date-and-time for each user account with the corresponding PC device; and
executing at least one specific reminder with the corresponding PC device of the arbitrary account, if the specific reminder matches the current date-and-time, wherein the specific reminder is from the plurality of calendar reminders of the arbitrary account.

14. The method of searching and sharing of virtual business cards as claimed in claim 13 comprises the steps of:
prompting each user account to enter at least one new reminder with the corresponding PC device; and
appending the new reminder into the plurality of calendar reminders for the arbitrary account with the corresponding PC device, if the new reminder is entered by the arbitrary account.
